(19) United States
(12) Patent Application Publication
(10) Pub. No.: US 2018/0166181 A1
(43) Pub. Date: Jun. 14, 2018

(54) Energy Superposition Material Modification Platform and Modification Method Thereof

(71) Applicant: Aiping Guan, Shenzhen, Guangdong (CN)

(72) Inventor: Aiping Guan, Shenzhen, Guangdong (CN)

(21) Appl. No.: 15/576,796

(22) PCT Filed: May 27, 2016
(86) PCT No.: PCT/CN2016/083705

§ 371 Date: Jan. 29, 2018

(30) Foreign Application Priority Data
May 28, 2015 (CN) 201520357569.3
May 25, 2016 (CN) 201610354887.3

(51) Int. Cl. G21K 5/10; G21F 3/00; G10K 11/24; H01F 13/00

(52) U.S. Cl. CPC G21K 5/10; H01F 13/00; G10K 11/24; G21F 3/00

(57) ABSTRACT

The present invention discloses an energy superimposition substance modifying platform and a modifying method thereof; the energy superimposition substance modifying platform includes a shield body (10A, 10B), and an radioactive source (30A, 30B) and a modified substance pipe (20A, 20B, 20C) provided in the shield body (10A, 10B), the modified substance pipe (20A, 20B, 20C) is provided with a modified substance inlet and a modified substance outlet; the substance to be modified and processed passes through the modified substance pipe (20A, 20B, 20C) and receives radiation of the radioactive source (30A, 30B); the radioactive source (30A, 30B) is a radionuclide or an irradiation device; and the substance to be modified is a lumpy solid or a granular solid.

### FIELD OF TECHNOLOGY

The present invention relates to a substance modifying platform and also an irradiation equipment, and more particularly to an equipment for continuous radioactive irradiation on a substance and a modifying method.

### BACKGROUND TECHNOLOGY

Since Röntgen discovered X-rays in 1895 and Madame Curie discovered the element radium in 1898, radioactive isotopes and radioactive devices such as cobalt 60 and accelerators have been successively discovered and manufactured. Nuclear science and technology have also been continuously developed and applied to various industries, profoundly changing the world. Examples are X-ray examination and tumor radiotherapy in the medical aspects; radioactive mineral processing in mining; nuclear power generation and detection of welding spots and cracks in metal castings in the industrial aspects; radiological identification of the era antiquities belong to in the field of archaeology; cobalt 60 irradiation sterilization in food and drug industries; and radiation breeding in agriculture, etc. Therefore, nuclear science has brought huge benefits to mankind.

However, up to now, no literature has reported on methods and devices using the theory of quantum mechanics to transfer radioactive nuclear energy to substances (including solids and fluids) in a certain way so that the substances become high-energy substances after obtaining the nuclear energy.

### SUMMARY

In order to remedy the defects of the above prior art, an objective of the present invention is to provide an energy superimposition substance modifying platform and a modifying method thereof.

The technical solution of the present invention is:

An energy superimposition substance modifying platform, including a shield body, and an emission source and a modified substance pipe provided in the shield body, the modified substance pipe is provided with a modified substance inlet and a modified substance outlet; the substance to be modified and processed passes through the modified substance pipe and receives radiation of the emission source; the emission source is a radionuclide or an irradiation device; and the substance to be modified is a lumpy solid or a granular solid.

An energy superimposition substance modifying platform, in which a substance to be modified is a fluid, is an irradiation equipment for fluid processing, including a shield body, and a radioactive source and a fluid pipe provided in the shield body, the fluid pipe is provided with a fluid inlet and a fluid outlet; a fluid to be processed flows through the fluid pipe and is subject to radiation from the radioactive source; the radioactive source is a radionuclide or an irradiation device; and the fluid is a liquid or a gas, or a granular solid propelled by a liquid or a gas under pressure.

A further technical solution is: the irradiation device is an accelerator, a neutron generator or a proton generator; and the radionuclide is cobalt 60, polonium, radium, uranium, iodine 125, iodine-131, cesium-137 or iridium 192.

A further technical solution is: the pipe is a straight pipe located in the middle of the shield body; and the emission source is disposed on the side of the straight pipe; or, the pipe is an annular pipe provided in the shield body; the emission source includes an internal emission source provided in a central cavity of the annular pipe, and two ends of the central cavity are provided with shield end covers.

A further technical solution is: an inlet of the shield body further couples with a magnetization device, the magnetic field strength of the magnetization device is 0.5-10 T, the magnetization device is provided with a substance magnetization channel, and an outlet of the substance magnetization channel is in communication with the inlet of the shield body.

A further technical solution is: further includes an infrared irradiation device provided between the magnetization device and the shield body; the infrared irradiation device is provided with a substance infrared irradiation channel, and the substance infrared irradiation channel is docked between the outlet of the substance magnetization channel and the inlet of the shield body;

and/or,
further includes an ultrasonic generator coupled with the outlet of the shield body, the ultrasonic generator is provided with a substance ultrasonic channel, and an inlet of the substance ultrasonic channel is in communication with the outlet of the shield body.

A further technical solution is: further includes a magnetization device, an infrared irradiation device, and an ultrasonic generator; the shield body and the internal structure thereof form a nuclear energy irradiation device; the magnetization device, the infrared irradiation device, the ultrasonic generator and the nuclear energy irradiation device carry out combined superimposition in one of the following three ways and to achieve energy superimposition on a substance to be modified:

sequential superimposition; first magnetized by the magnetization device, then irradiated by the infrared irradiation device, then subjected to ultrasonic treatment by the ultrasonic generator, and finally nuclear energy irradiation by the nuclear energy device.
stack superimposition: the magnetization device, the far-infrared irradiation device, the ultrasonic generator and the nuclear energy device are concentrated in one position to simultaneously superimpose four kinds of energy on the substance to be modified; and
first sequential superimposition, and then stack superimposition; the substance to be modified is divided into three, each is first processed by the magnetization device, the infrared irradiation device, and the nuclear energy device, and finally gathered at the ultrasonic generator for centralized synthesis processing.

A further technical solution is: an outlet of the shield body is further coupled with an ultrasonic generator, the ultrasonic generator is provided with a substance ultrasonic channel, and an inlet of the substance ultrasonic channel is in communication with the outlet of the shield body.

In an energy superimposition substance modifying method of the present invention, the method uses radiation generated by a radionuclide or an irradiation device to irradiate a substance to be modified, after absorbing the radiation, the substance to be modified becomes a high-energy substance; wherein, the radionuclide is cobalt 60, polonium, radium, uranium, iodine 125, iodine-131, cesium-137 or iridium 192; the irradiation device is an accelerator, a neutron generator or a proton generator; the radiation comprises α rays, β rays, γ rays, or X rays; the substance to be modified is a solid or a fluid; the solid is a lumpy solid or a granular solid; and the fluid is a liquid or a gas, or a granular solid propelled by a liquid or a gas under pressure.

A further technical solution is: during irradiation, the substance to be modified is rotated or the emission source is rotated, wherein, the pipe diameter of the modified substance pipe is 5-500 mm, the moving speed of the modified substance pipe is 3-1000 mm/s, the irradiation time is 0.5-60 minutes, and the radiation intensity is 0.5-80 Gy/min.

In a method for processing a fuel additive according to the present invention, the method uses radiation generated by a radionuclide or an irradiation device to irradiate a liquid raw material, after absorbing the radiation, the liquid raw material becomes a fuel additive; wherein, the radionuclide is cobalt 60, polonium, radium, uranium, iodine 125, iodine-131, cesium-137 or iridium 192; the irradiation device is an accelerator, a neutron generator or a proton generator; and the radiation comprises α rays, β rays, γ rays, or X rays; wherein, the pipe diameter of the fluid pipe is 5-500 mm, the flow velocity of the fluid is 3-1000 mm/s, the irradiation time is 0.5-60 minutes, and the radiation intensity is 0.5-80 Gy/min.

The working mechanism of the present invention is described as follows:

Taking fuel as an example, it is large molecules in a state of groups of molecules under normal conditions. At the time of fuel burning in a cylinder where groups of molecules have inadequate contact and mixing with oxygen, oil molecules that have no contact and mixing with oxygen no doubt are not combusted, resulting in incomplete combustion of fuel.

Why do single oil molecules form groups of molecules or long molecular chains? It is because of the van der Waals attraction (hereinafter referred to van's attraction) among molecules (van der Waals, a Dutch theoretical physicist, won the 1910 Nobel Prize in Physics for the discovery and proof of van der Waals attraction).

To allow complete combustion of fuel, the problem of van's attraction must be solved to turn groups of molecules into single molecules.

For this reason, Chinese entrepreneurs, mainly private entrepreneurs, have made extremely arduous efforts to this end or they will not have more than 1,200 products available. Unfortunately, the vast majority of entrepreneurs do not know about the van's attraction problem, and instead sell as an additive at gas stations after mixing some oxygenating or cleaning agents. The effect is not good or there is even no effect.

How to solve the van's attraction problem, of course, mechanical problems can only be solved by physical mechanics. In the '80s and '90s of the last century, many scholars have proposed methods using ultrasonic, magnetizing force and infrared force to solve, offset and destroy van's attraction, and made some progress. However, since the forces are too week, they cannot offset van's attraction. For example, magnetization need to reach 10 T, i.e. one hundred thousand Gauss, to make gasoline magnetized.

In the last century, Professor Yang Zhenning, a Chinese-American physicist and winner of the Nobel Prize in Physics, once said that quantum mechanics when applied in practice will have tremendous economic and social benefits. Unfortunately, the world has made use of this theory to create only one product, the nuclear magnetic resonance (MRI).

According to the basic theory of the master of quantum mechanics, Professor Dirac, a British theoretical physicist and winner of the 1943 Nobel Prize in Physics: all substances have energy, under certain conditions, according to the theory of quantum mechanics, using magnetization, nuclear energy technology and equipment to process special oil extracts into energy additives, which are added into gasoline, diesels and heavy oils to overcome the van der Waals attraction among oil molecules, to break down fuel large molecules into single small molecules, and to promote complete combustion of fuel. This can save fuel, eliminate coke, clean engines, reduce emissions of pollutants, and achieve environmental protection purposes.

Compared with the prior art, the present invention has the following beneficial effects: the present invention adopts a shield body structure where a substance to be modified passes through a modified substance pipe located in the shield body, and is subject to radiation from a radioactive source located in the shield body to achieve energy transfer. The substance to be modified can be radioactively irradiated to improve physical properties of the substance to be modified, overcoming the van der Waals attraction among molecules, breaking down large molecules into single small molecules, such as promoting complete combustion of fuel, making solid substances having higher solubilities, etc. Wherein, taking fuel additive as an example, after a liquid raw material absorbs radiant energy, some of the hydrocarbon chains with weaker chemical bonds are cracked to generate smaller hydrocarbon molecular chains. As a result, heavy components are reduced and light components are increased, forming a fuel additive. Because the light components in the fuel are easier to completely burn than the heavy components, they are added to the fuel. The combustion efficiency of the fuel after absorbing nuclear energy is significantly improved, and the combustion effects for simultaneous magnetization, infrared irradiation and ultrasonic treatment are better. The present invention can also be used for irradiation processing of other fluids, such as industrial fluid additives. It can also be used for radioactive irradiation of gases, and can also be used for processing of granular or lumpy solids. Such as processing film of quantum optical fibers, granular raw material of the film is irradiated to improve the properties of the raw material. Granular solids can be pressured to achieve a flow of granular solids, or uses a liquid as a carrier to achieve a flow of radiation. It can also be used for modifying lumpy solids or granular solids. In order to have a better modification effect, energy superimposition treatment steps of magnetization treatment, infrared irradiation treatment and/or ultrasonic treatment or device may be added before or after nuclear energy irradiation.

The present invention will be further described below with reference to the drawings and specific embodiments.

### BRIEF DESCRIPTION OF DRAWINGS

FIG. 1 is a structural schematic diagram of a first embodiment of the energy superimposition substance modifying platform according to the present invention;

FIG. 2 is a structural schematic diagram of a second embodiment of the energy superimposition substance modifying platform according to the present invention;

FIG. 3 is a structural schematic diagram of a third embodiment of the energy superimposition substance modifying platform according to the present invention;

FIG. 4 is a structural schematic diagram of a fourth embodiment of the energy superimposition substance modifying platform according to the present invention;

FIG. 5 is a comparison diagram (pollutant emission and fuel consumption) of the modification results of the energy superimposition substance modifying method (using a fuel additive as the modified substance) according to the present invention;

FIG. 6 is a comparison diagram (total engine power) of the modification results of the energy superimposition substance modifying method (using a fuel additive as the modified substance) according to the present invention;

FIG. 7 is a comparison diagram (engine load characteristics at 2000 r/min) of the modification results of the energy superimposition substance modifying method (using a fuel additive as the modified substance) according to the present invention;

FIG. 8 is a comparison diagram (engine load characteristics at 3000 r/min) of the modification results of the energy superimposition substance modifying method (using a fuel additive as the modified substance) according to the present invention;

FIG. 9 is a comparison diagram (engine load characteristics at 4000 r/min) of the modification results of the energy superimposition substance modifying method (using a fuel additive as the modified substance) according to the present invention;

FIG. 10 is a comparison diagram (exhaust pollutants) of the modification results of the energy superimposition substance modifying method (using a fuel additive as the modified substance) according to the present invention;

FIG. 11 is a comparison diagram (torque curve) of the modification results of the energy superimposition substance modifying method (using a fuel additive as the modified substance) according to the present invention;

FIG. 12 is a comparison diagram (power curve) of the modification results of the energy superimposition substance modifying method (using a fuel additive as the modified substance) according to the present invention;

FIG. 13 is a comparison diagram (fuel consumption rate curve at 2000 r/min) of the modification results of the energy superimposition substance modifying method (using a fuel additive as the modified substance) according to the present invention;

FIG. 14 is a comparison diagram (fuel consumption rate curve at 3000 r/min) of the modification results of the energy superimposition substance modifying method (using a fuel additive as the modified substance) according to the present invention;

FIG. 15 is a comparison diagram (fuel consumption rate curve at 5000 r/min) of the modification results of the energy superimposition substance modifying method (using a fuel additive as the modified substance) according to the present invention;

FIG. 16A is a structural schematic diagram of superimposition (sequential superimposition) when multiple energy modification is used according to the energy superimposition substance modifying method of the present invention;

FIG. 16B is a structural schematic diagram of superimposition (stack superimposition) when multiple energy modification is used according to the energy superimposition substance modifying method of the present invention; and

FIG. 16C is a structural schematic diagram of superimposition (first sequential superimposition, and then stack superimposition) when multiple energy modification is used according to the energy superimposition substance modifying method of the present invention.

### REFERENCE NUMERALS

| | | | |
|---|---|---|---|
| 10A | Shield body | 10B | Shield body |
| 11 | Shield base | 12 | Shield upper cover |
| 19 | Side vertical board | 20 | Straight pipe |
| 20B | Annular pipe | 20C | Annular pipe |
| 21 | Inner pipe | 22 | Outer pipe |
| 23 | End cover | 24 | Partition |
| 28 | Shield end cover | 29 | Central cavity |
| 30A | External radioactive source | 30B | Internal radioactive source |
| 40 | Rotating body | 41 | Outer bearing |
| 411 | Baffle | 412 | Groove |
| 421 | Baffle | 422 | Groove |
| 42 | Inner bearing | 47 | Ring gear |
| 48 | Transmission mechanism | 49 | Motor |
| S1 | Irradiation equipment | S2 | Irradiation equipment |
| S3 | Irradiation equipment | S4 | Irradiation equipment |

### DETAILED DESCRIPTION

In order to more fully understand the technical content of the present invention, the technical solutions of the present invention are further described and illustrated with reference to specific embodiments, but not limited thereto.

According to the theory of quantum mechanics, all kinds of substances have energy, and this kind of energy can be transferred to each other under certain conditions. The present invention applies the above theory of quantum mechanics to transfer radioactive nuclear energy to a fluid in a certain way so that substances (such as lumpy solids, granular solids, or fluids) become high-energy substances after obtaining the nuclear energy.

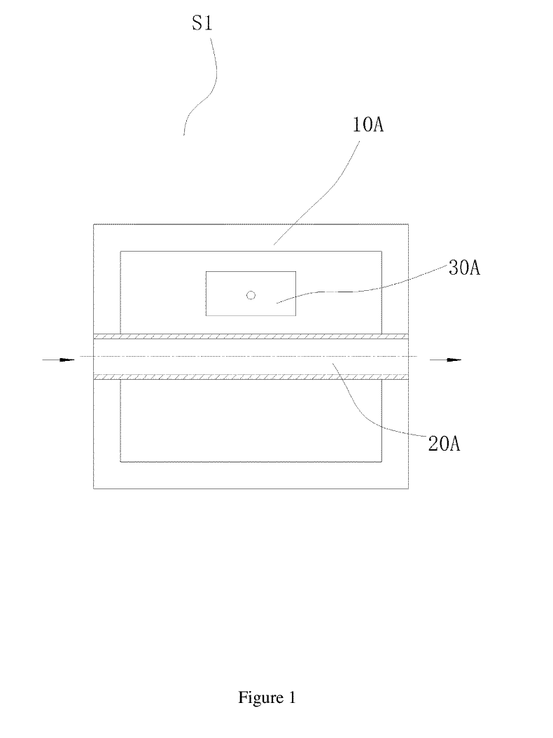

As shown in FIG. 1, an energy superimposition substance modifying platform S1 of the present invention, also referred to as an irradiation equipment for fluid processing, includes a shield body 10A, and a radioactive source and a fluid pipe provided in the shield body 10A, the fluid pipe is provided with a fluid inlet and a fluid outlet; a fluid to be processed flows through the fluid pipe and is subject to radiation from the radioactive source. Wherein, the fluid pipe is a straight pipe 20A, and the radioactive source is an external radioactive source 30A disposed outside the straight pipe. Wherein, the radioactive source is a radionuclide or an irradiation device. Wherein, the radioactive source adopts conventional structure in the prior art and will not be described in detail. Wherein, there can be one radioactive source, and can also be two or three radioactive sources. In this embodiment, the substance to be modified is a fluid, the fluid includes a liquid or a gas, or a granular solid propelled by a liquid or a gas under pressure.

When the radioactive source is an irradiation device, it can be an accelerator, a neutron generator or a proton generator; when the radioactive source is a radionuclide, it can be cobalt 60, polonium, radium, uranium, iodine 125, iodine-131, cesium-137 or iridium 192.

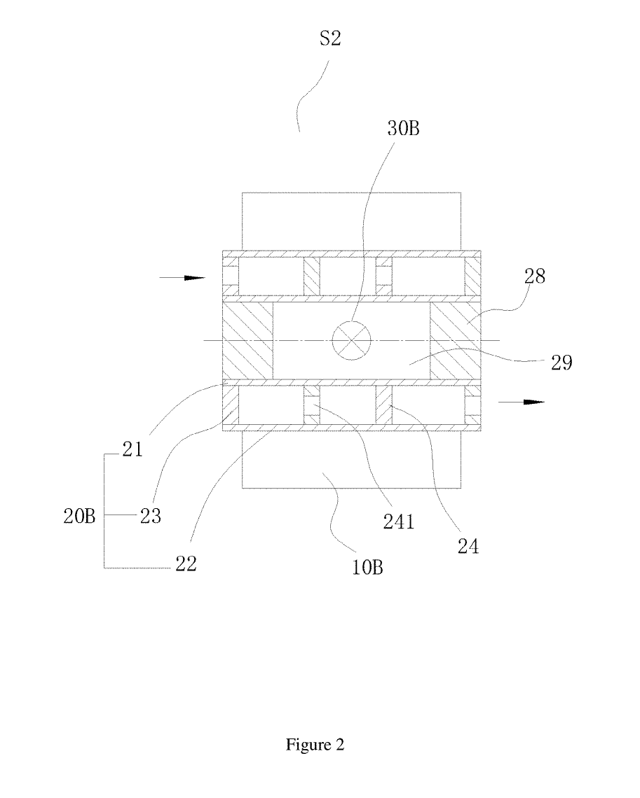

In the embodiment shown in FIG. 2, the differences from the embodiment of FIG. 1 lie in that the fluid pipe is an annular pipe 20B provided in the shield body 10B; the radioactive source is an internal radioactive source 30B disposed in a central cavity 29 of the annular pipe 20B, shield end covers 28 are provided at both ends of the central cavity 29. In order to facilitate processing, the annular pipe 20B may adopt a concentric inner pipe 21 and an outer pipe 22 welded together through end covers 23, and the two end covers 23 are respectively provided with a fluid inlet fitting and a fluid outlet fitting (not shown in the figure). In order to make the route (or time) for the fluid flowing pass the internal radioactive source longer, two partitions 24 may be further provided in the annular pipe 20B, and through holes 241 offset by 180 degrees are provided on the two partitions 24.

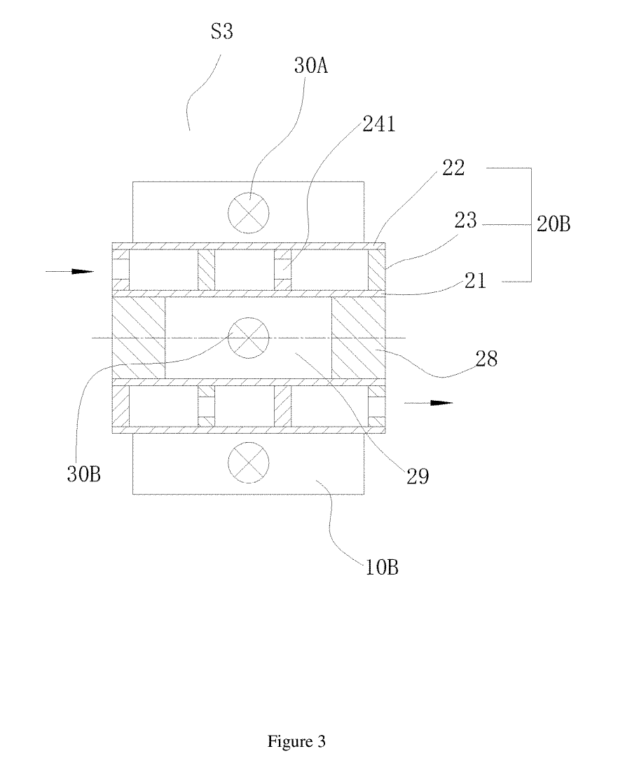

In the embodiment shown in FIG. 3, the difference from the embodiment of FIG. 2 lies in that the radioactive source further includes an external radioactive source 30A provided outside the annular pipe 20B.

In other embodiments, the annular pipe may not be a concentric annular pipe, but employs a spiral pipe to form an annular pipe that allows a fluid to move in a spiral. Such structure does not require addition of partitions as in the embodiments of FIGS. 2 and 3.

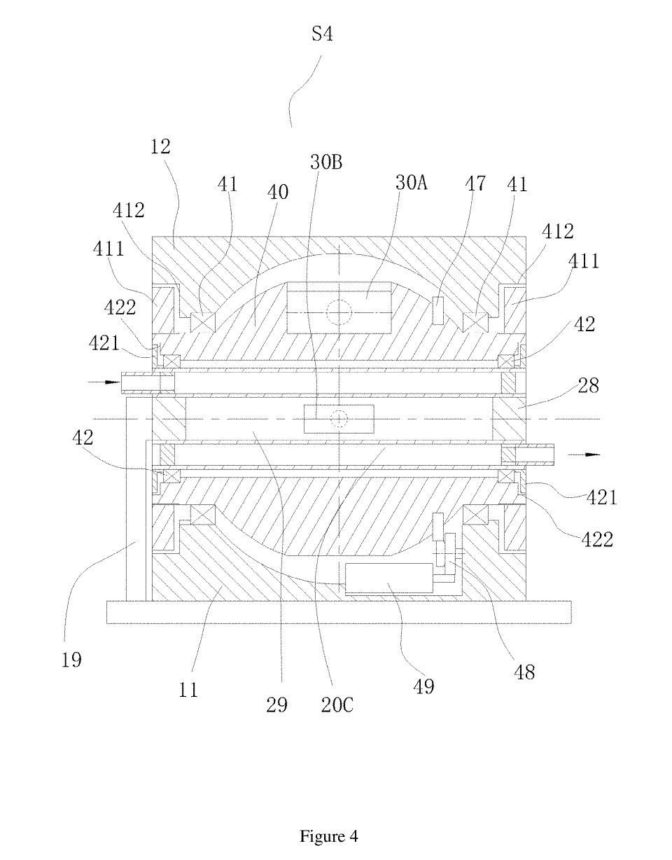

The embodiment shown in FIG. 4 is similar to the embodiment shown in FIG. 3 except that the external radioactive source can be rotated. The specific structure is that: a shield body includes a shield base 11 and a shield upper cover 12 detachably coupled to and above the shield base 11 (the boundary of the two is preferably located at the centreline of the rotating body); an annular pipe 20C is fixed to the shield base 11 by a side vertical board 19; further includes a rotating body 40 annularly disposed on the outer periphery of the annular pipe 20C; and above the rotating body 40 is provided with an external radioactive source 30A.

Wherein, two outer bearings 41 are disposed between the rotating body 40 and the shield body, and inner bearings 42 are disposed between the rotating body 40 and the annular pipe 20C. In order to achieve better shielding effect, baffles 411 fixed to the rotating body (corresponding grooves 412 are provided on the shield body) are provided outside the outer bearings 41, and baffles 421 fixed to ends of the annular pipe 20C (corresponding grooves 422 are provided on the rotating body) are provided outside the inner bearings 42.

In order to drive the rotating body 40, a motor 49 and a transmission mechanism 48 drivingly coupled with the motor 49 are provided in the shield base 11. Wherein, the transmission mechanism 48 is a reduction gear set, and a ring gear 47 that meshes with the reduction gear set is provided on the rotating body 40.

Wherein, the rotating body can be in continuous rotation, and can also be in reciprocating rotation of less than 360 degrees. When continuous rotation is employed, brush-type electrical contacts can be used for power supply of an irradiation device.

As a further preferred solution of each embodiment of the above modified platforms, a magnetization device may be further coupled with an inlet of the shield body. The magnetic field strength of the magnetization device is 0.5-10 T. The magnetization device is provided with a substance magnetization channel, and an outlet of the substance magnetization channel is in communication with the inlet of the shield body.

Further, it also includes an infrared irradiation device provided between the magnetization device and the shield body. The infrared irradiation device is provided with a substance infrared irradiation channel, and the substance infrared irradiation channel is docked between the outlet of the substance magnetization channel and the inlet of the shield body.

Further, the outlet of the shield body is further coupled with an ultrasonic generator. The ultrasonic generator is provided with a substance ultrasonic channel, and an inlet of the substance ultrasonic channel is in communication with the outlet of the shield body.

A nuclear energy irradiation device can also be formed from a magnetization device, an infrared irradiation device, an ultrasonic generator, and a shield body and the internal structure thereof, to carry out combined superimposition in one of the following three ways and to achieve energy superimposition on a substance to be modified:

Sequential superimposition: first magnetized by a magnetization device, then irradiated by an infrared irradiation device, then subjected to ultrasonic treatment by an ultrasonic generator, and finally nuclear energy irradiation by a nuclear energy device.

Stack superimposition: a magnetization device, a far-infrared irradiation device, an ultrasonic generator and a nuclear energy device are concentrated in one position to simultaneously superimpose four kinds of energy on the substance to be modified.

First sequential superimposition, and then stack superimposition: the substance to be modified is divided into three, each is first processed by a magnetization device, an infrared irradiation device, and a nuclear energy device, and finally gathered at an ultrasonic generator for centralized synthesis processing.

An energy superimposition substance modifying platform of the present invention where the substance to be modified may also be a lumpy solid or a granular solid, includes a shield body, and an emission source and a modified substance pipe provided in the shield body, the modified substance pipe is provided with a modified substance inlet and a modified substance outlet; the substance to be modified and processed passes through the modified substance pipe and receives radiation of the emission source; and the emission source is a radionuclide or an irradiation device. In addition to the need of adding a power device for transporting solids, other structures may be referred to the structure of the irradiation equipment for fluid processing described above. The power device for transporting solids may employ a belt conveyor mechanism. The modified substance pipe, the substance magnetization channel, the substance infrared irradiation channel and the substance ultrasonic channel are all of gate structures (i.e. the bottoms are flat for setting the belt). Lumpy solids are transported on the belt in each channel.

As a more preferred solution, taking into account the shielding needs of the shield body, the inlet and outlet of the shield body are of a retractable structure, and during the nuclear energy irradiation (i.e. during operation of the irradiation device), the belt stops, a lumpy solid (substance to be modified) is parked at each of the inlet and outlet, the retractable structure is tightened to form a shield structure with the parked lumpy solid; and when the irradiation device stops working, the belt moves to drive the lumpy solid to move forward for a certain distance, and the lumpy solid which is sent into the shield body is irradiated with nuclear energy. This structure employs an intermittent manner to carry out nuclear energy irradiation, magnetization, infrared irradiation and ultrasonic treatment.

In an energy superimposition substance modifying method of the present invention, the method uses radiation generated by a radionuclide or an irradiation device to irradiate a substance to be modified. After absorbing the radiation, the substance to be modified becomes a high-energy substance; wherein, the radionuclide can be cobalt 60, polonium, radium, uranium, iodine 125, iodine-131, cesium-137 or iridium 192; the irradiation device can be an accelerator, a neutron generator or a proton generator; the radiation includes α rays, β rays, γ rays, or X rays; the substance to be modified is a solid or a fluid; the solid is a lumpy solid or a granular solid; and the fluid is a liquid or a gas, or a granular solid propelled by a liquid or a gas under pressure.

During irradiation, the substance to be modified is rotated or the emission source is rotated, wherein, the pipe diameter of the modified substance pipe is 5-500 mm, the moving speed of the modified substance pipe is 3-1000 mm/s, the irradiation time is 0.5-60 minutes, and the radiation intensity is 0.5-80 Gy/min.

Still another method of the present invention is a method for processing a fuel additive. The method uses radiation generated by a radionuclide or an irradiation device to irradiate a liquid raw material. After absorbing the radiation, the liquid raw material becomes a fuel additive; wherein, the radionuclide can be cobalt 60, polonium, radium, uranium, iodine 125, iodine-131, cesium-137 or iridium 192; the irradiation device can be an accelerator, a neutron generator or a proton generator; and the radiation includes α rays, β rays, γ rays, or X rays; wherein, the pipe diameter of the fluid pipe is 5-500 mm, the flow velocity of the fluid is 3-1000 mm/s, the irradiation time is 0.5-60 minutes, and the radiation intensity is 0.5-80 Gy/min.

In other embodiments, the fluid can also be used for other liquids, such as industrial fluid additives, can also be used for radioactive irradiation of gases, and can also be used for processing of granular solids. Such as processing film of quantum optical fibers, granular raw material of the film is irradiated to improve the properties of the raw material. Granular solids can be pressured to achieve a flow of granular solids, or uses a liquid as a carrier to achieve a flow of radiation.

As a further preferred solution of each embodiment of the above modifying methods, a magnetization treatment may be performed prior to the nuclear energy irradiation. The magnetic field strength of the magnetization treatment is 0.5-10 T.

Further, infrared irradiation can be performed between magnetization treatment and the nuclear energy irradiation.

Still further, ultrasonic treatment can be performed during nuclear energy irradiation.

It is also possible to carry out combined superimposition on the magnetization step, the infrared irradiation step, the ultrasonic generation step, and the nuclear energy irradiation process in one of the following three ways and to achieve energy superimposition on the substance to be modified:

Sequential superimposition: first magnetization, then irradiation, further ultrasonic treatment, and finally nuclear energy irradiation by a nuclear energy device.

Stack superimposition: the magnetization step, the far-infrared irradiation step, the ultrasonication step, and the nuclear energy step are concentrated in one position to simultaneously superimpose four kinds of energy on the substance to be modified.

First sequential superimposition, and then stack superimposition: the substance to be modified is divided into three, each is first processed through magnetization treatment, infrared irradiation treatment, and nuclear energy irradiation treatment, and finally gathered at an ultrasonic generator for centralized synthesis processing.

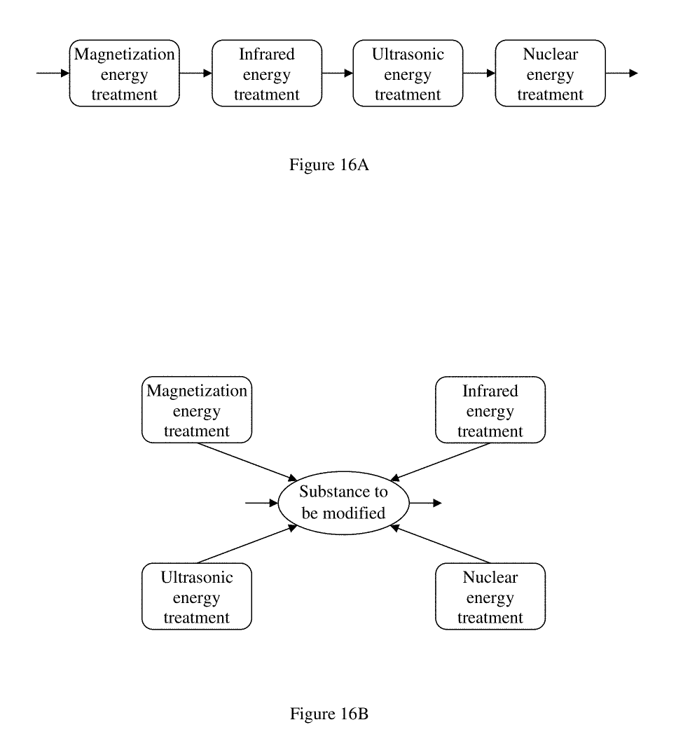

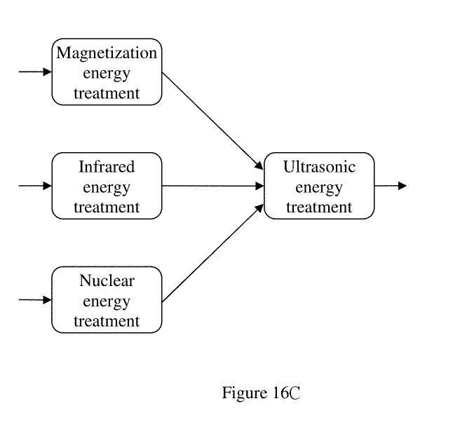

See FIGS. 16A-16C for the specific structures.

For specific implementation, a one-piece structure can be employed (such as addition of a magnetization device, an infrared irradiation device and/or an ultrasonic processing device to the structures shown in FIGS. 1-4), and it is also possible to couple a magnetization device, a nuclear energy irradiation device (i.e. the shield body and the internal structure thereof), an infrared irradiation device and an ultrasonic processing device respectively by pipes to form a substance modification production line.

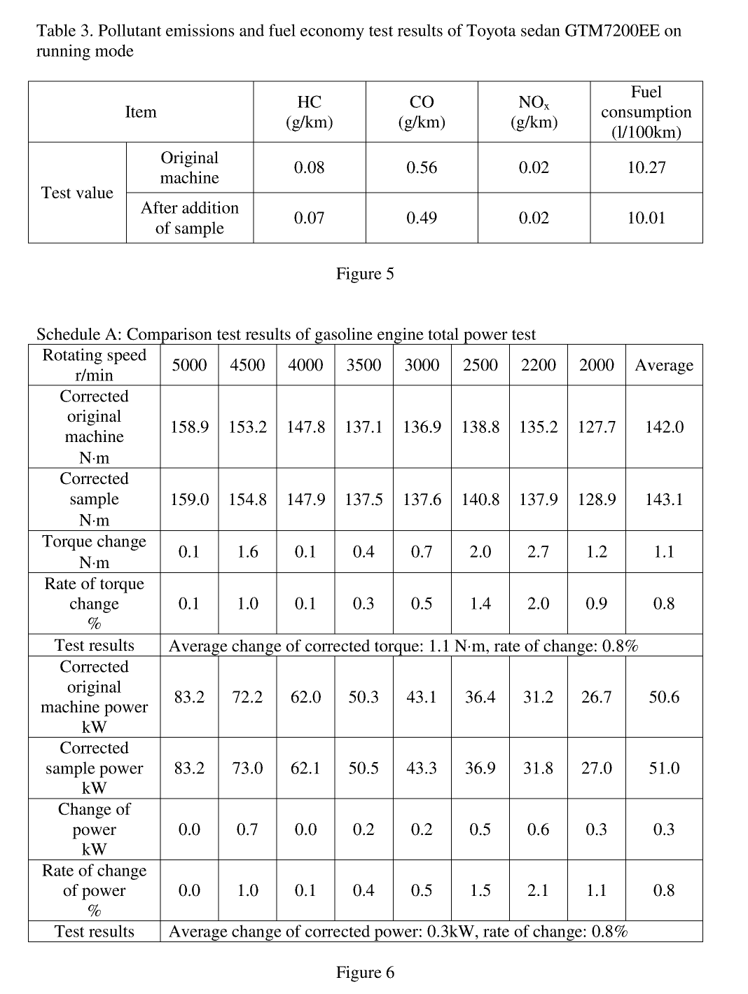

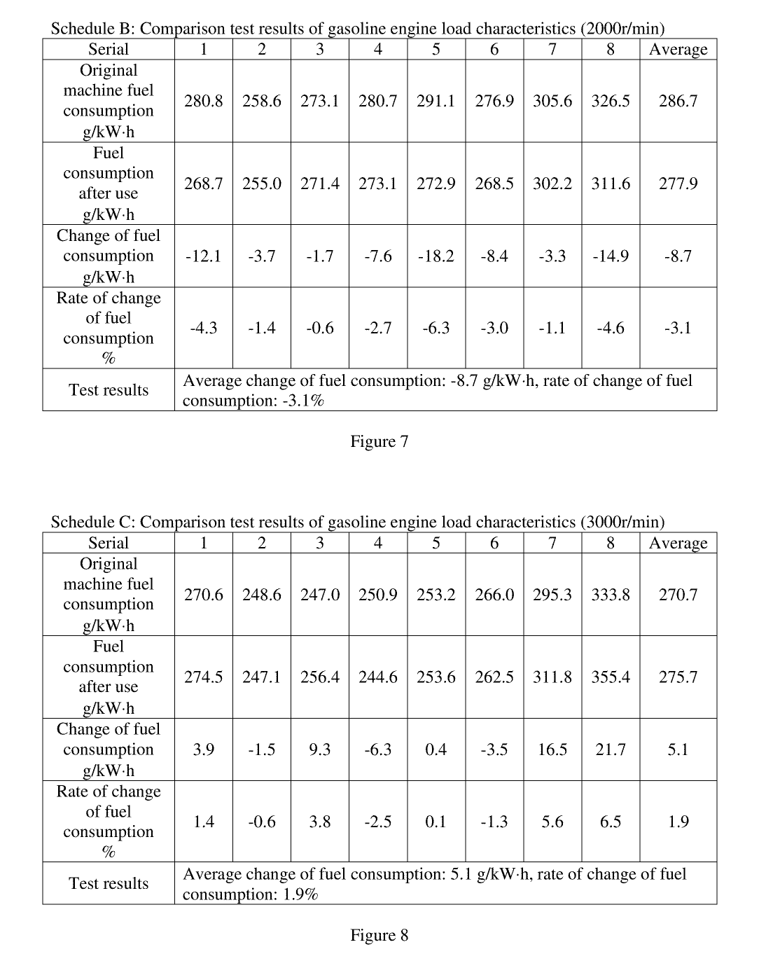

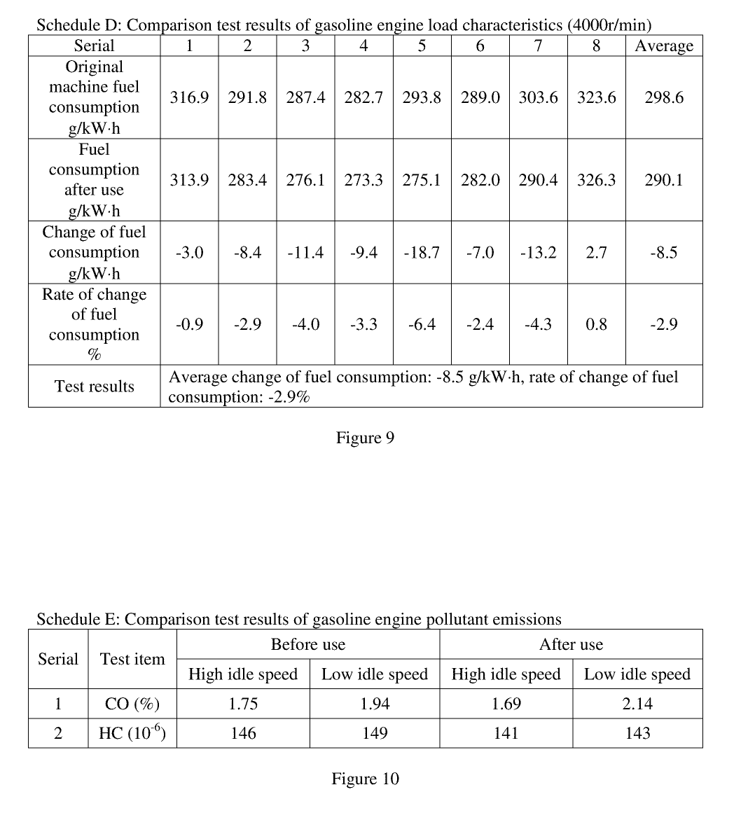

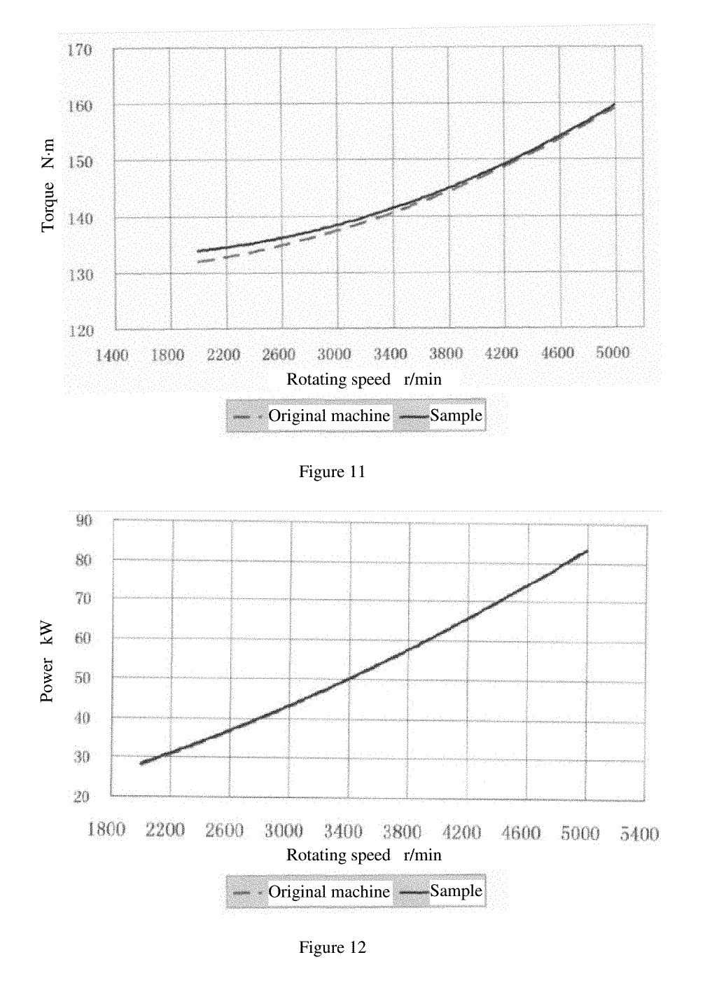

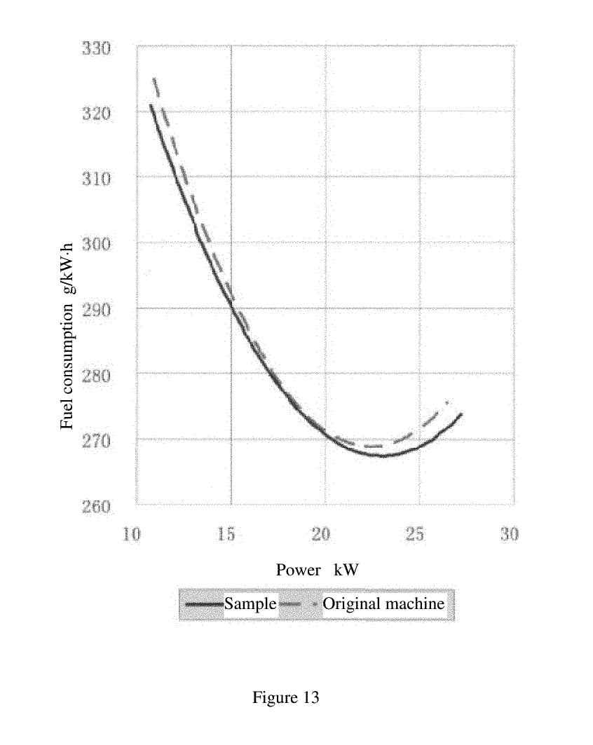

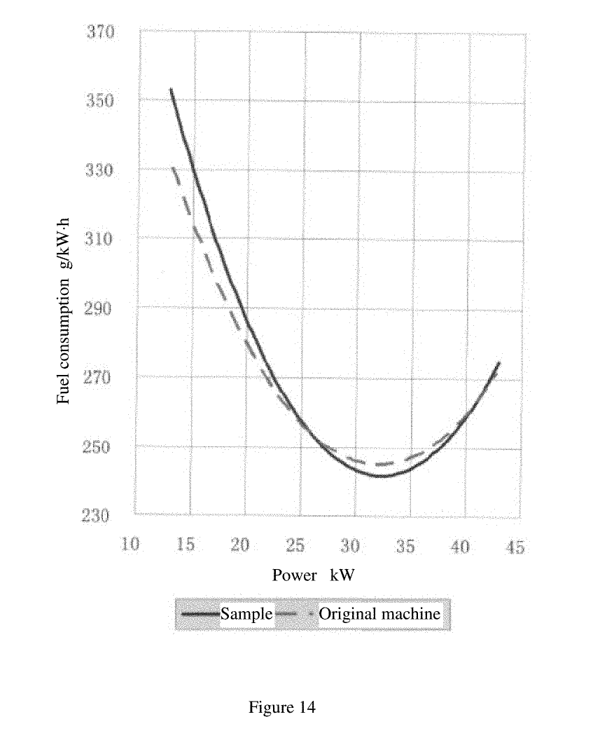

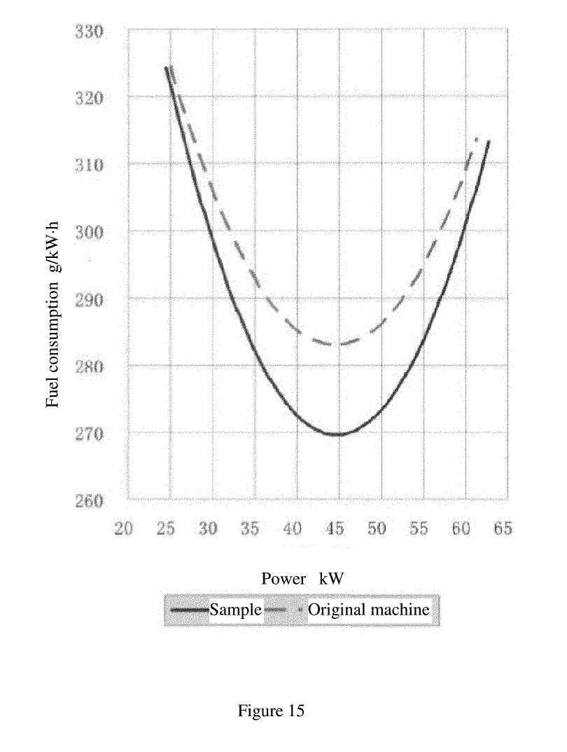

The modifying method of the present invention adopts aviation kerosene as a substance to be modified, and is produced as a fuel additive after magnetization treatment and nuclear energy irradiation. After testing by Vehicle Emission Control Center, Chinese State Environmental Protection Administration, YouJingLing (product name of a fuel additive) was used to dilute the tested gasoline at a ratio of 1:500. Hydrocarbons, nitrogen oxides and carbon monoxide were greatly reduced at the same time. See FIG. 5-14 for the specific results. The sample machine in the figures refers to a car engine using a fuel additive processed by the method of the present invention (using gasoline no. 92) and the original machine is a car engine using commercially available gasoline (gasoline no. 92 of the same batch). Comparison table of test results of the produced fuel additive and exhaust emissions standards of various countries is as follows:

| | | | | | | The | | | |
|---|---|---|---|---|---|---|---|---|---|
| | | | | | | strictest | | | |
| | YouJingLing | | | | | standard of | | | |
| | test | | Reduction | | Reduction | California, | Reduction | Japan | Reduction |
| | results | China 4 | rate (%) | Euro 5 | rate (%) | USA (SUV20) | rate (%) | (2009) | rate (%) |
| HC | 0.07 | 0.10 | 30% | 0.10 | 30% | ※NMOG + | — | ※NMHC | — |
| (Hydrocarbons) | | | | | | NOx | | Not | |
| (g/km) | | | | | | Not | | comparable | |
| NOx | 0.02 | 0.08 | 75% | 0.06 | 67% | comparable | | 0.05 | 60% |
| (Nitrogen | | | | | | | | | |
| oxides) | | | | | | | | | |
| (g/km) | | | | | | | | | |
| CO | 0.49 | 1.00 | 51% | 1.00 | 51% | 0.62 | 21% | 1.15 | 57% |
| (Carbon | | | | | | | | | |
| monoxide) | | | | | | | | | |
| (g/km) | | | | | | | | | |

※NMOG: Non-methane organic gas
※NMHC: Non-methane hydrocarbons

Comparing YouJingLing (i.e. a fuel additive obtained by the method of the present invention) test results with the China 4 standards, the hydrocarbon value was 30% lower than the standard, nitrogen oxides value was 75% lower than the standard, and the carbon monoxide value was 51% lower than the standard;

Comparing YouJingLing test results with the Euro 5 standards, the hydrocarbon value was 30% lower than the standard, nitrogen oxides value was 67% lower than the standard, and the carbon monoxide value was 51% lower than the standard;

Comparing YouJingLing test results with the SULEV20 grade (the strictest grade) under the LEV III standards of California, USA, since the standards used for hydrocarbons and nitrogen oxides do not correspond to the test results, they are not comparable. However, the carbon monoxide value was 21% lower than the standard; and

Comparing YouJingLing test results with the Japanese motor vehicle emission standards, the standard used for hydrocarbons does not correspond to the test result, so they are not comparable. However, nitrogen oxides value was 60% lower than the standard and carbon monoxide value was 57% lower than the standard.

Therefore, it can be concluded that, after using YouJingLing, motor vehicles (small cars) can pass the top exhaust emission standards in various countries over the world, and at the same time it shows that, after using YouJingLing, the emission is the lowest in the world.

In summary, the present invention adopts a shield body structure. Fluid to be processed flows through a fluid pipe located in a shield body and is irradiated by a radioactive source located in the shield body to achieve energy transfer. Specific fluids can be radioactively irradiated to improve performance of the fluids, and it is beneficial to batch processing and production of fluids.

The technical content of the present invention was further described above by way of example only, so as to be easily understood by readers. However, it is not meant that the embodiments of the present invention are limited thereto. Any extension or re-creation of the technology made according to the present invention shall be protected by the present invention. The protection scope of the present invention is subject to the claims.

1. An energy superimposition substance modifying platform, comprising a shield body, and an emission source and a modified substance pipe provided in the shield body, the modified substance pipe is provided with a modified substance inlet and a modified substance outlet; the substance to be modified and processed passes through the modified substance pipe and receives radiation of the emission source; the emission source is a radionuclide or an irradiation device; and the substance to be modified is a lumpy solid or a granular solid.

2. An energy superimposition substance modifying platform, in which a substance to be modified is a fluid, is an irradiation equipment for fluid processing, comprising a shield body, and a radioactive source and a fluid pipe provided in the shield body, the fluid pipe is provided with a fluid inlet and a fluid outlet; a fluid to be processed flows through the fluid pipe and is subject to radiation from the radioactive source; the radioactive source is a radionuclide or an irradiation device; and the fluid is a liquid or a gas, or a granular solid propelled by a liquid or a gas under pressure.

3. The energy superimposition substance modifying platform according to claim 1, wherein the irradiation device is an accelerator, a neutron generator or a proton generator; and the radionuclide is cobalt 60, polonium, radium, uranium, iodine 125, iodine-131, cesium-137 or iridium 192.

4. The energy superimposition substance modifying platform according to claim 1, wherein:
the pipe is a straight pipe located in the middle of the shield body; and the emission source is disposed on the side of the straight pipe; or
the pipe is an annular pipe provided in the shield body; the emission source comprises an internal emission source provided in a central cavity of the annular pipe, and two ends of the central cavity are provided with shield end covers.

5. The energy superimposition substance modifying platform according to claim 1, wherein an inlet of the shield body further couples with a magnetization device, the magnetic field strength of the magnetization device is 0.5-10 T, the magnetization device is provided with a substance magnetization channel, and an outlet of the substance magnetization channel is in communication with the inlet of the shield body.

6. The energy superimposition substance modifying platform according to claim 5, further comprises an infrared irradiation device provided between the magnetization device and the shield body; the infrared irradiation device is provided with a substance infrared irradiation channel, and the substance infrared irradiation channel is docked between the outlet of the substance magnetization channel and the inlet of the shield body;
and/or,
further comprises an ultrasonic generator coupled with the outlet of the shield body, the ultrasonic generator is provided with a substance ultrasonic channel, and an inlet of the substance ultrasonic channel is in communication with the outlet of the shield body.

7. The energy superimposition substance modifying platform according to claim 1, further comprises a magnetization device, an infrared irradiation device, and an ultrasonic generator; the shield body and the internal structure thereof form a nuclear energy irradiation device; the magnetization device, the infrared irradiation device, the ultrasonic generator and the nuclear energy irradiation device carry out combined superimposition in one of the following three ways and to achieve energy superimposition on a substance to be modified:
sequential superimposition: first magnetized by the magnetization device, then irradiated by the infrared irradiation device, then subjected to ultrasonic treatment by the ultrasonic generator, and finally nuclear energy irradiation by the nuclear energy irradiation device;
stack superimposition: the magnetization device, the infrared irradiation device, the ultrasonic generator and the nuclear energy irradiation device are concentrated in one position to simultaneously superimpose four kinds of energy on the substance to be modified; and
first sequential superimposition, and then stack superimposition: the substance to be modified is divided into three, each is first processed by the magnetization device, the infrared irradiation device, and the nuclear energy irradiation device, and finally gathered at the ultrasonic generator for centralized synthesis processing.

8. An energy superimposition substance modifying method using radiation generated by a radionuclide or an irradiation device to irradiate a substance to be modified, after absorbing the radiation, the substance to be modified becomes a high-energy substance; wherein, the radionuclide is cobalt 60, polonium, radium, uranium, iodine 125, iodine-131, cesium-137 or iridium 192; the irradiation device is an accelerator, a neutron generator or a proton generator; the radiation comprises α rays, β rays, γ rays, or X rays; the substance to be modified is a solid or a fluid; the solid is a lumpy solid or a granular solid; and the fluid is a liquid or a gas, or a granular solid propelled by a liquid or a gas under pressure.

9. The energy superimposition substance modifying method according to claim 8, wherein during irradiation, the substance to be modified is rotated or the emission source is rotated, wherein, the pipe diameter of the modified substance pipe is 5-500 mm, the moving speed of the modified substance pipe is 3-1000 mm/s, the irradiation time is 0.5-60 minutes, and the radiation intensity is 0.5-80 Gy/min.

10. (canceled)

11. The energy superimposition substance modifying platform according to claim 2, wherein the irradiation device is an accelerator, a neutron generator or a proton generator; and the radionuclide is cobalt 60, polonium, radium, uranium, iodine 125, iodine-131, cesium-137 or iridium 192.

12. The energy superimposition substance modifying platform according to claim 2, wherein:
the pipe is a straight pipe located in the middle of the shield body; and the emission source is disposed on the side of the straight pipe; or
the pipe is an annular pipe provided in the shield body; the emission source comprises an internal emission source provided in a central cavity of the annular pipe, and two ends of the central cavity are provided with shield end covers.

13. The energy superimposition substance modifying platform according to claim 2, wherein an inlet of the shield body further couples with a magnetization device, the magnetic field strength of the magnetization device is 0.5-10 T, the magnetization device is provided with a substance magnetization channel, and an outlet of the substance magnetization channel is in communication with the inlet of the shield body.

14. The energy superimposition substance modifying platform according to claim 13, further comprises an infrared irradiation device provided between the magnetization device and the shield body; the infrared irradiation device is provided with a substance infrared irradiation channel, and the substance infrared irradiation channel is docked between the outlet of the substance magnetization channel and the inlet of the shield body;
and/or,
further comprises an ultrasonic generator coupled with the outlet of the shield body, the ultrasonic generator is provided with a substance ultrasonic channel, and an inlet of the substance ultrasonic channel is in communication with the outlet of the shield body.

15. The energy superimposition substance modifying platform according to claim 2, further comprises a magnetization device, an infrared irradiation device, and an ultrasonic generator; the shield body and the internal structure thereof form a nuclear energy irradiation device; the magnetization device, the infrared irradiation device, the ultrasonic generator and the nuclear energy irradiation device carry out combined superimposition in one of the following three ways and to achieve energy superimposition on a substance to be modified:
sequential superimposition: first magnetized by the magnetization device, then irradiated by the infrared irradiation device, then subjected to ultrasonic treatment by the ultrasonic generator, and finally nuclear energy irradiation by the nuclear energy irradiation device;
stack superimposition: the magnetization device, the infrared irradiation device, the ultrasonic generator and the nuclear energy irradiation device are concentrated in one position to simultaneously superimpose four kinds of energy on the substance to be modified; and
first sequential superimposition, and then stack superimposition: the substance to be modified is divided into three, each is first processed by the magnetization device, the infrared irradiation device, and the nuclear energy irradiation device, and finally gathered at the ultrasonic generator for centralized synthesis processing.
